(19) United States
(12) Patent Application Publication
(10) Pub. No.: US 2016/0379532 A1
(43) Pub. Date: Dec. 29, 2016

(54) VEHICLE LOCATION ASSISTANCE ASSEMBLY

(71) Applicant: Lauresa Tomlinson, Mc Kinleyville, CA (US)

(72) Inventor: Lauresa Tomlinson, Mc Kinleyville, CA (US)

(21) Appl. No.: 14/750,336

(22) Filed: Jun. 25, 2015

(51) Int. Cl. G09F 17/00; B60R 11/00

(52) U.S. Cl. CPC G09F 17/00; B60R 11/00; B60R 2011/004; B60R 2011/0056; G09F 2017/0075

(57) ABSTRACT

A vehicle location assistance assembly includes a base that has a top side and a bottom side. A post is attached to the top side of the base. The post is telescopic and is movable between an extended position and a retracted position. A flag is attached to the post adjacent to an apex of the post. The flag is retained adjacent to the apex such that the flag rises or lowers as the apex rises or lowers. A coupler is attached to the base and to attaches the base to a roof of a vehicle.

### BACKGROUND OF THE DISCLOSURE

Field of the Disclosure

The disclosure relates to vehicle locating devices and more particularly pertains to a new vehicle locating device for assisting a person in locating a vehicle in a crowded area such as a parking lot.

### SUMMARY OF THE DISCLOSURE

An embodiment of the disclosure meets the needs presented above by generally comprising a base that has a top side and a bottom side. A post is attached to the top side of the base. The post is telescopic and is movable between an extended position and a retracted position. A flag is attached to the post adjacent to an apex of the post. The flag is retained adjacent to the apex such that the flag rises or lowers as the apex rises or lowers. A coupler is attached to the base and to attaches the base to a roof of a vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a vehicle location assistance assembly according to an embodiment of the disclosure.

FIG. 2 is a top view of an embodiment of the disclosure.

FIG. 3 is a side view of an embodiment of the disclosure.

FIG. 4 is a bottom view of an embodiment of the disclosure.

FIG. 5 is a cross-sectional view of an embodiment of the disclosure take along line 5-5 of FIG. 2.

FIG. 6 is a schematic view of an embodiment of the disclosure.

### DESCRIPTION OF THE PREFERRED EMBODIMENT

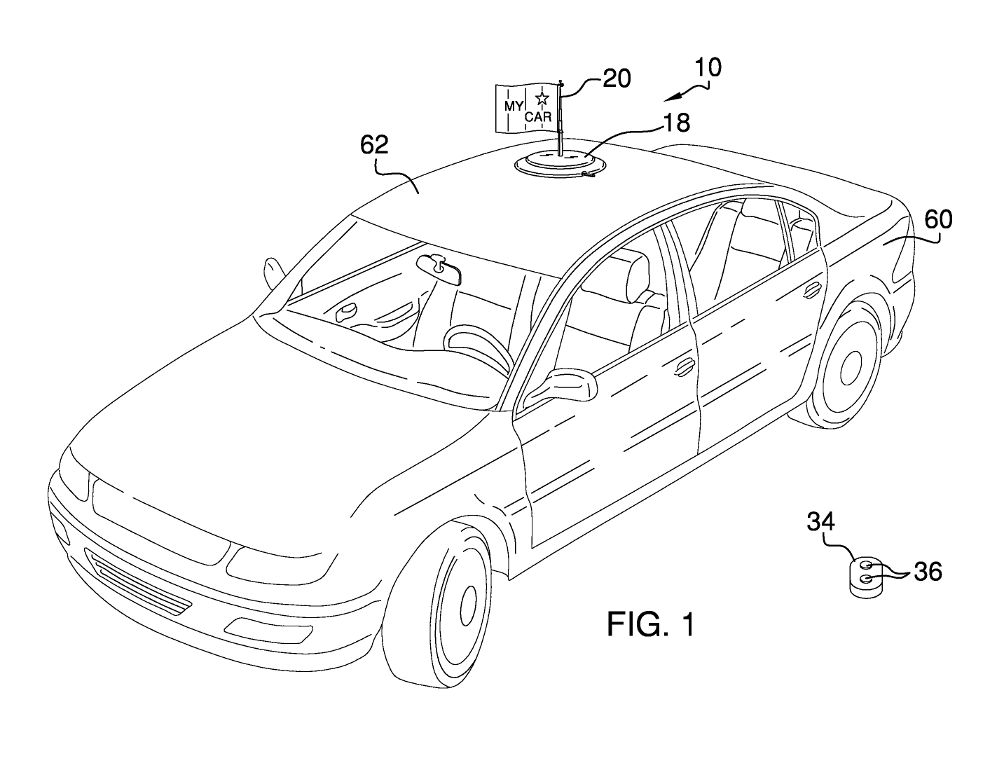

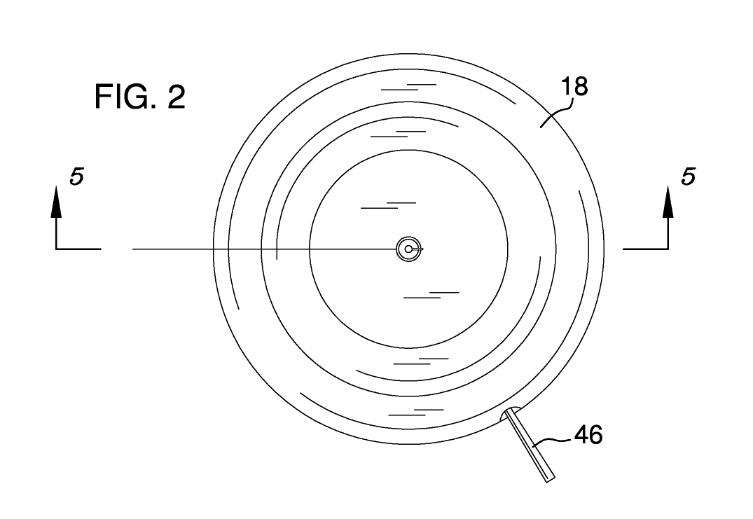

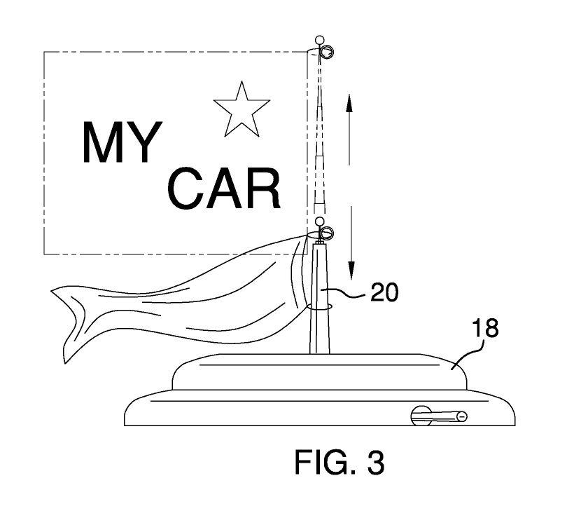

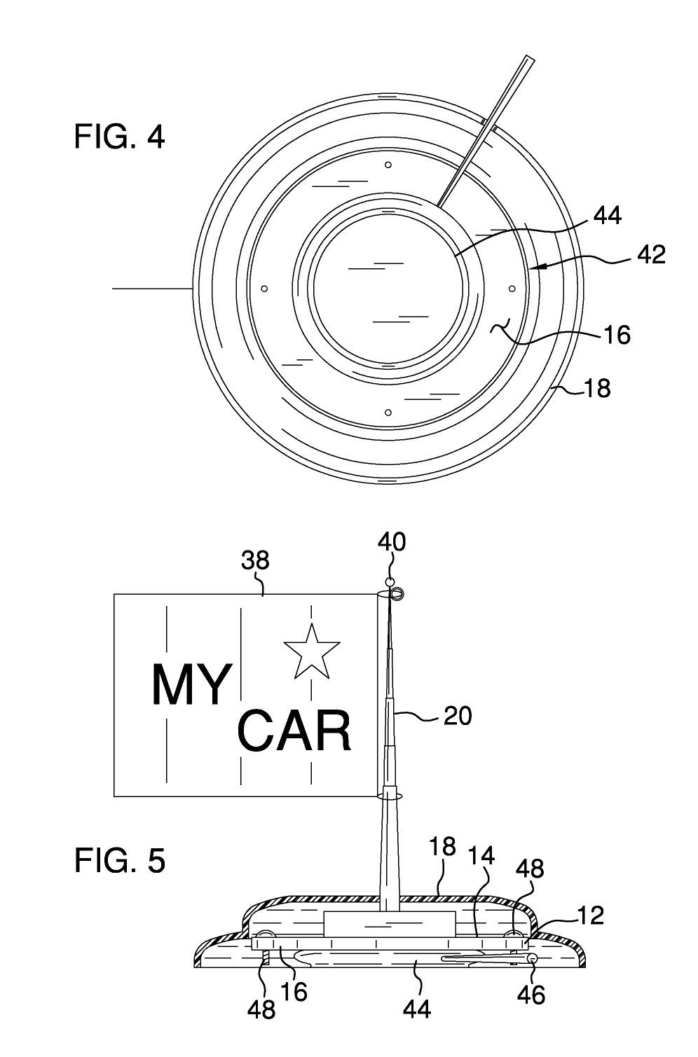

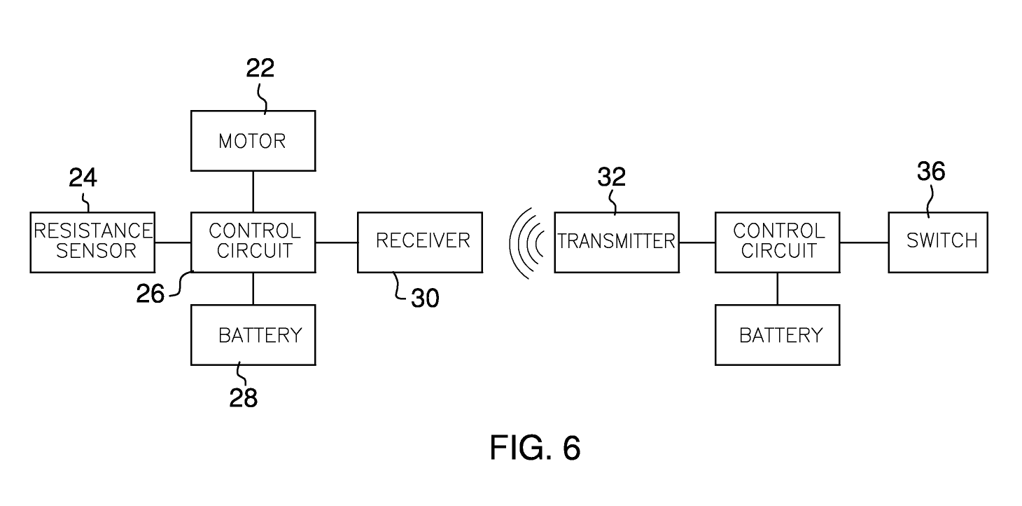

With reference now to the drawings, and in particular to FIGS. 1 through 6 thereof, a new vehicle locating device embodying the principles and concepts of an embodiment of the disclosure and generally designated by the reference numeral 10 will be described.

As best illustrated in FIGS. 1 through 6, the vehicle location assistance assembly 10 generally comprises a base 12 that has a top side 14 and a bottom side 16. The base 1 may be covered with a housing 18 as can be seen in the Figures to protect the base 1 and structures stated below from the elements or from tampering.

A post 20 is attached to the top side 14 of the base 12. The post 20 is telescopic and is movable between an extended position and a retracted position. The extended position is greater than at least 30.0 inches and the retracted position is less than 12.0 inches. A motor 22 is mounted on the base 12 and is engaged to the post 20. The motor 22 is actuated in a first direction to raise the post 20 to the extended position and actuated in a second direction to lower the post 20 to the retracted position. The motor 22 and post 20 are conventional to automatic vehicle antenna systems used for extending an antenna out of a vehicle and then retracting the antenna to a stored position within the vehicle. A resistance sensor 24 may be included such that if the motor 22 detects resistance to the raising of the post 20, which may occur if the post 20 strikes an overhead object, the motor 22 will stop.

A control circuit 26 is electrically coupled to the motor 22 and a receiver 30 for receiving wireless, i.e. radio, signals is electrically coupled to the control circuit 22. A battery 28 may be mounted on the base 12 or within a motor housing for powering the motor 22, control circuit 26 and receiver 30. A transmitter 32 is provided that is configured for transmitting a wireless signal to the receiver 30. Such may be housed in a small container 34 that is positionable on a key chain. The transmitter 32 includes a switch 36 and the transmitter 32 sends a raise signal or a lower signal when the switch 36 is actuated. The switch 36 may include a pair of switches 36 such that one is used for raising the post 20 and the other is used for lowering the post 20.

A flag 38 is attached to the post 20 adjacent to an apex 40 of the post 20 and is retained adjacent to the apex 40 such that the flag 38 rises or lowers as the apex 40 rises or lowers. The flag 38 may have any indicia thereon such that the user easily recognizes the flag 38 as theirs. A coupler 42 is attached to the base 12 and is configured to attach the base to a roof 62 of a vehicle 60. The coupler 42 may comprise, for instance, a suction cup 44 which includes a lever 46 to assist the user in removal and attachment of the suction cup 44 to the vehicle 60. Alternatively, the suction cup 44 may be removed and conventional fasteners 48 such as screws or bolts may be sued to secure the base 12 to the vehicle 60.

In use, the user attaches the base 12 to the roof 62 of the vehicle 60 using one of the structures discussed above. When the user wishes to locate their vehicle, they actuate the switch 36 to cause the transmitter 32 to transmit the raise signal to the receiver 30 which in turn causes the control circuit 26 to drive the motor 22 in the first direction. When the post 20 is extended the flag 38 will be easily visible so that the user can more easily locate their vehicle 60. After the vehicle 60 is located, the user may actuate the switch 36 to send the lower signal and cause the motor 22 to be driven in the second direction.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle locating system to facilitate the location of a vehicle in a parking area, said system comprising:
a base having a top side and a bottom side;
a post being attached to said top side of said base, said post being telescopic and being movable between an extended position and a retracted position;
a flag being attached to said post adjacent to an apex of said post, said flag retained adjacent to said apex such that said flag rises or lowers as said apex rises or lowers; and
a coupler being attached to said base, said coupler being configured to attach said base to a roof of a vehicle.

2. The vehicle locating system according to claim 1, wherein said extended position is greater than 30.0 inches and said retracted position is less than 12.0 inches.

3. The vehicle locating system according to claim 1, wherein said coupler comprises a suction cup.

4. The vehicle locating system according to claim 1, further including:
a control circuit being electrically coupled to said motor;
a receiver being electrically coupled to said control circuit; and
a transmitter configured for transmitting a wireless signal to said receiver, including a switch, said transmitter sending a raise signal or a lower signal when said switch is actuated.

5. A vehicle locating system to facilitate the location of a vehicle in a parking area, said system comprising:
a base having a top side and a bottom side;
a post being attached to said top side of said base, said post being telescopic and being movable between an extended position and a retracted position, said extended position being greater than 30.0 inches and said retracted position being less than 12.0 inches;
a flag being attached to said post adjacent to an apex of said post, said flag retained adjacent to said apex such that said flag rises or lowers as said apex rises or lowers;
a coupler being attached to said base, said coupler being configured to attach said base to a roof of a vehicle, said coupler comprising a suction cup;
a motor being mounted on said base and being engaged to said post, said motor being actuated in a first direction to raise said post to said extended position and actuated in a second direction to lower said post to said retracted position;
a control circuit being electrically coupled to said motor;
a receiver being electrically coupled to said control circuit; and
a transmitter configured for transmitting a wireless signal to said receiver, including a switch, said transmitter sending a raise signal or a lower signal when said switch is actuated.
